(19) United States
(12) Patent Application Publication
(10) Pub. No.: US 2026/0084896 A1
(43) Pub. Date: Mar. 26, 2026

(54) Integration of transfer devices in a high-bay warehouse

(71) Applicant: AMOVA GmbH, Hilchenbach (DE)

(72) Inventors: Volker BRÜCK, Mudersbach (DE); Bernd BÜDENBENDER, Siegen (DE)

(73) Assignee: AMOVA GmbH, Hilchenbach (DE)

(21) Appl. No.: 19/113,551

(22) PCT Filed: Oct. 27, 2023
(86) PCT No.: PCT/EP2023/080037

§ 371 Date: Mar. 20, 2025

(30) Foreign Application Priority Data
Nov. 7, 2022 (DE) 10 2022 129 323.8

(51) Int. Cl. B65G 1/04; B65G 63/00

(52) U.S. Cl. CPC B65G 1/0428; B65G 63/004; B65G 2201/0235

(57) ABSTRACT

A high-bay warehouse for storing and retrieving containers has a plurality of storage spaces, arranged horizontally adjacent to and vertically above one another and storage aisles arranged between groups of storage spaces and extending parallel to one another. In each storage aisle at least one storage and retrieval machine can be moved back and forth to move the containers vertically and horizontally and into and out of the storage spaces. A transport route for transport vehicle is allocated to the high-bay warehouse. The transport route is arranged below the travel plane of the storage and retrieval machines and at least one device is provided for receiving and transporting storage and retrieval machines, which device spans the transport route and is configured to receive at least one storage and retrieval machine and to move same between at least two storage aisles perpendicularly to the longitudinal orientation of the storage aisles.

### CROSS-REFERENCE TO RELATED APPLICATION

This application is a national stage application, filed under 35 U.S.C. § 371, of International Patent Application PCT/EP2023/080037, filed on Oct. 27, 2023, which claims the benefit of German Patent Application DE 10 2022 129 323.8, filed on Nov. 7, 2022.

### TECHNICAL FIELD

The disclosure relates to a high-bay warehouse for storing and retrieving containers and to a method for reducing and/or increasing the number of operating devices per storage aisle in such a high-bay warehouse.

### BACKGROUND

High-bay warehouses or HBS (High Bay Storage) are well known from the prior art and are widely used, especially in handling facilities at sea or inland ports. The high-bay warehouses usually have a large number of shelf compartments, arranged horizontally adjacent to and vertically above one another, preferably separate shelf compartments, and storage aisles arranged between groups of shelf compartments and extending parallel to one another, in each of which storage aisles at least one storage and retrieval device can be moved back and forth and is designed to move the containers vertically and horizontally and into and out of the shelf compartments.

An example of such a high-bay warehouse is disclosed in WO 2015/1243482 A1. In this high-bay warehouse, standard containers are picked up by a storage and retrieval machine at a transfer point within the high-bay warehouse and then transported by the storage and retrieval machine to a predefined shelf compartment and stored in this shelf compartment. The containers are grabbed from above while hanging and stored laterally in the respective shelf compartments by means of a telescopic system so that the longitudinal side of the container is aligned parallel to the storage aisle. This leads to maximum use of space within the rack storage system, since the storage aisles only need to be designed slightly wider than the respective ends of the containers. This special handling and storage of containers, especially empty containers, also means that, if the telescopic systems on the storage and retrieval machines are suitably designed, two adjacently arranged shelf compartments can be served on each side from each storage aisle, thus a total of four shelf compartments (“double deep”).

Within each storage aisle, at least one storage and retrieval machine is usually provided, via which each container can be transferred from a specified receiving position to the respective shelf compartment, and a container can also be removed from the shelf compartment again and brought to a suitable transfer position in order then to be picked up by an external transport vehicle directly or indirectly with the interposition of suitable transfer devices.

The ability of the respective storage and retrieval machine to pick up, move and release a container again, as well as the number of storage and retrieval machines within a storage aisle, is the determining factor for the handling capacity of the high-bay warehouse, which is usually finally determined when the high-bay warehouse is at the design stage. Converting the high-bay warehouse by reducing or increasing the number of storage and retrieval machines per storage aisle is time-consuming and expensive.

### SUMMARY

It is an object of the disclosure to provide a high-bay warehouse and a method for reducing and/or increasing the number of storage and retrieval machines per storage aisle in such a high-bay warehouse, which are suitable for overcoming the problems known from the prior art and for obtaining a higher degree of flexibility as well as a high-bay warehouse that can be adjusted and converted to the respective predicted or desired turnover of containers per time. This object is achieved with a high-bay warehouse and a method as disclosed and claimed.

A high-bay warehouse for storing and retrieving containers is provided, having a plurality of storage spaces, arranged horizontally adjacent to and vertically above one another, for containers and storage aisles arranged between groups or levels of storage spaces and extending parallel to one another, in each of which storage aisles at least one storage and retrieval machine can be moved back and forth, this storage and retrieval machine being designed to move the containers vertically and horizontally and into and out of the storage spaces. Typically, such groups of storage spaces are provided in a modular manner, extending over almost the entire length and height of the rack storage system. The storage spaces are preferably provided as separately arranged shelf compartments and can therefore also be accessed separately by at least one storage and retrieval machine in order to store or retrieve a container. The containers are therefore received in the shelf compartments individually or at most in pairs, whereby there only needs to be sufficient space above the containers for the operation of the storage and retrieval machine's transport equipment, in particular telescopic systems with which the containers can be supported in a hanging position and moved into the shelf compartments perpendicularly to the storage aisles.

The high-bay warehouse has a device for transporting at least one storage and retrieval machine perpendicularly to the longitudinal orientation of the storage aisles, which is designed and configured to receive at least one storage and retrieval machine and to move it between at least two storage aisles. The device for transporting the storage and retrieval machine(s) is arranged above a transport route for external transport vehicle or transport vehicle allocated to the high-bay warehouse, which is also oriented perpendicularly to the longitudinal orientation of the storage aisles and arranged below the level in which the storage and retrieval machines are moved. The device for transporting at least one storage and retrieval machine spans this transport route for transport vehicle in such a way that the transport vehicle, possibly loaded with containers, can be moved unhindered along the transport route and the device for transporting at least one storage and retrieval machine can also be moved between at least two storage aisles independently of the occupancy of the transport route with or without a storage and retrieval machine.

It is preferred if the transport route is arranged on at least one end of the high-bay warehouse. Typically, a high-bay warehouse is connected to external transport routes by arranging the transport route directly next to a high-bay warehouse, it being preferred if the transport route(s) for, for example, rail-bound vehicles or lorries are connected to the high-bay warehouse in such a way that the storage and retrieval machines can move the containers picked up to the transport route itself or into its immediate vicinity. The container can then be transferred from the storage and retrieval machine to the external transport vehicle directly or using an appropriate transfer device in the form of a roller conveyor, a crane device and/or another transfer device. The vertical arrangement of the transport route to the high-bay warehouse means that the transfer from each storage aisle of the high-bay warehouse to the transport route can take place in the same way. Likewise, each storage aisle can be accessed from the transport route in the same way. If the transport route is arranged on one end of the high-bay warehouse, preferably on both ends of the high-bay warehouse, optimal use of space and a minimal transport route from the high-bay warehouse to the external transport vehicle or from the external transport vehicle into the high-bay warehouse can be achieved.

It is preferred if the device for receiving and transporting storage and retrieval machines is provided so as to be movable over a distance which corresponds at least to the distance between all storage aisles within the high-bay warehouse. This creates a high-bay warehouse that allows the exchange of all storage and retrieval machines from all storage aisles and thus enables the greatest possible flexibility for the use of all available storage and retrieval machines. Depending on requirements, each storage aisle can then be equipped with more than one storage and retrieval machine, whilst, on the other hand, storage aisles that are at least temporarily unused can also remain without a storage and retrieval machine and the storage and retrieval machine not used there can be used in another storage aisle of the high-bay warehouse.

This also ensures that all control devices in the high-bay warehouse can be removed from the respective storage aisle in the event of a failure or any type of functional impairment and, if necessary, replaced and maintained and/or repaired outside the high-bay warehouse. It is particularly preferred if the device for receiving and transporting storage and retrieval machines can be moved on rails which are arranged on both sides of the transport route. This creates a device that can be operated particularly safely with a low probability of failure and susceptibility to errors.

In this context, it is particularly preferred if the rails are arranged on side boundaries for the transport route. It is also highly preferred in this context if the side boundaries extend from the level of the transport route to the travel plane of the storage and retrieval machines. This ensures, using simple means, that, on the one hand, the transport route can operate unhindered and, using simple means, that, on the other, the storage and retrieval machines can remain in their travel plane, which also corresponds to the level of the storage aisles, when leaving the storage aisles. This makes it particularly easy to replace storage and retrieval machines or transport them to another storage aisle or to a waiting position.

It is also preferred if at least one waiting position for unused storage and retrieval machines or for the maintenance of storage and retrieval machines is provided outside the high-bay warehouse and the device for receiving and transporting storage and retrieval machines is designed and configured to be moved between all storage aisles and the waiting position or at least the longitudinal extent of their supply route. The waiting position therefore does not necessarily have to be located within the travel route for the device for receiving and transporting storage and retrieval machines, it also being possible for it to be provided offset to the side, in which case a storage and retrieval machine is moved by the device for receiving and transporting storage and retrieval machines to a position from which the storage and retrieval machine can then reach the waiting position independently after leaving the device for receiving and transporting storage and retrieval machines, for example via rails provided for this purpose between the waiting position and the travel route for the device for receiving and transporting storage and retrieval machines.

In a further preferred embodiment, the device for receiving and transporting storage and retrieval machines has a chassis, preferably with at least one drive, in particular with a drive for each wheel, and a support structure, preferably a support frame, for supporting a storage and retrieval machine received within the device in a tilt-proof manner. This provides a device which, on the one hand, can be moved safely and, on the other, can ensure safe transport of a storage and retrieval machine at least between a first and a second storage aisle. It should be noted here that storage and retrieval machines for high-bay container warehouses have a ratio of height, weight and width that is inherently unfavourable for transport due to the limited width of the storage aisles. It is therefore preferred if the construction of the device for receiving and transporting storage and retrieval machines is designed in such a way that tilt-proof transport of a storage and retrieval machine is ensured. This is ensured, on the one hand, by the weight of the device for receiving and transporting storage and retrieval machines preferably itself being approximately the same order of magnitude as the deadweight of the storage and retrieval machine, for example approximately 200 t, with a height of more than 19 m, a width of more than 11 m and a length of more than 23 m and, if appropriate, on the other hand, the support structure, preferably the support frame, for securely supporting a storage and retrieval machine received within the device corresponds to at least 25%, preferably at least 30%, of the height of a storage and retrieval machine.

Preferably, the high-bay warehouse has at least one area that is designed and suitable for receiving empty containers stacked on top of each other. In this area for empty containers, which is located within the high-bay warehouse, no separate shelf compartments are provided, but at least one area is provided which does not have the separate shelf compartments otherwise provided for the containers. In this at least one area for empty containers, the empty containers can be arranged directly and immediately stacked on top of each other and can still be reached by means of the storage and retrieval machines. Particularly preferred is a high-bay warehouse which is designed exclusively to receive empty containers and can therefore preferably do without separate shelf compartments instead of storage spaces. This ensures that, on the one hand, separate stacking spaces for empty containers outside the high-bay warehouse can be dispensed with and, on the other, the handling of empty containers can be carried out automatically, preferably fully automatically, via the storage and retrieval machines within the high-bay warehouse.

It is preferred if the storage spaces or separate shelf compartments are designed and suitable for receiving a 20′ standard container (1 TEU, Twenty Foot Equivalent Unit) or a 40′ standard container (2 TEU) or for receiving two half-length standard containers arranged one behind the other in their longitudinal direction. This means that two 20′ standard containers adjacent to each other at their ends can be stored in a storage space or separate shelf compartment designed to receive a 40′ standard container, or two 10′ standard containers (0.5 TEU) can be stored in a storage space or separate shelf compartment designed to receive a 20′ standard container. This creates a high-bay warehouse that allows for fully automated handling of containers while making optimal use of space.

In this context, it is particularly preferred if the storage and retrieval machine can move the containers with their longitudinal sides aligned parallel to the storage aisles into and out of the storage spaces, preferably shelf compartments. On the one hand, this means that the arrangement of two rows of storage spaces, preferably shelf compartments, on each side of a storage and retrieval machine, as has already been described as preferred, is particularly advantageously supported, whilst, on the other hand, this also leads to a minimum width of the storage aisles required for the storage and retrieval machines.

Unlike loaded containers, empty containers are stacked directly and immediately on top of each other. However, due to discontinuities in the corner areas of the containers, what are referred to as “corner castings”, the stack may become unstable as the stack height increases. In the worst case, this may lead to the entire container or parts of it tipping over, possibly into the aisle of the storage and retrieval machine. In order to solve this problem, in a preferred embodiment, retaining devices can be provided on the high-bay warehouse itself, which in a particularly preferred embodiment are mounted at regular intervals, preferably on both sides of the stack or the areas for empty containers. It is highly preferred if such retaining devices are attached to the vertical uprights of the high-bay warehouse.

In this context, it is particularly preferred if the high-bay warehouse is designed in such a way that it can handle more than 2500 standard containers per hectare per year (2500 TEU/ha), preferably more than 3000 TEU/ha, most preferably more than 5000 TEU/ha. The unit TEU per hectare shown here represents a standard measure for the capacity of port logistics and in particular of high-bay warehouses. The above-described stacking areas for empty containers outside high-bay warehouses and operation with specially designed vehicles, such as reach stackers or the like, achieve an annual handling capacity of no more than 2500 TEU/ha. The high-bay warehouse is capable of increasing the handling of both loaded and empty containers, preferably in a fully automated manner, beyond this known level.

According to a further aspect, a method is provided for reducing and/or increasing the number of storage and retrieval machines per storage aisle in a high-bay warehouse according to the first aspect described above. Within this high-bay warehouse, the containers are picked up by means of the storage and retrieval machines, transported to the respective shelf compartments and stored there. Depending on requirements, in order to increase or reduce the number of storage and retrieval machines in a respective storage aisle, storage and retrieval machines are led out of a storage aisle by means of a device for transporting at least one storage and retrieval machine perpendicularly or transversely to the longitudinal orientation, then picked up by the device, or fed by the device for transporting at least one storage and retrieval machine into the respective storage aisle or in front of the respective storage aisle and led from there into the storage aisle.

Typically, a storage and retrieval machine is removed from operation in a first storage aisle and transferred to operation in a second storage aisle. However, the invention may also encompass the removal of a storage and retrieval machine from a storage aisle and its transfer to a waiting position, possibly outside the high-bay warehouse, or the increase in the number of storage and retrieval machines within a storage aisle by transferring a storage and retrieval machine from a waiting position, possibly outside the high-bay warehouse, to operation in a storage aisle. In such a case, the number of storage and retrieval machines within the other storage aisles would remain unchanged.

The invention therefore comprises a method in which, in a first alternative, a storage and retrieval machine is removed from a first storage aisle and moved to a second storage aisle by means of the device for receiving and transporting storage and retrieval machines in order then to continue operation in this second storage aisle. In a second alternative, a storage and retrieval machine is moved from a waiting position, possibly a waiting position outside the high-bay warehouse, to a storage aisle by means of the device for receiving and transporting storage and retrieval machines and is operated there, increasing the number of storage and retrieval machines used in this storage aisle. In a third alternative embodiment, a storage and retrieval machine is removed from a storage aisle, then moved by the device for receiving and transporting storage and retrieval machines to a waiting position in order to be kept, repaired or maintained in the waiting position.

In any case, the movement of the storage and retrieval machine between the respective storage aisles and/or a storage aisle and the waiting position regularly means that a storage and retrieval machine is moved completely out of the storage aisle, preferably by rail, in order then to be moved transversely to the longitudinal orientation of the respective storage aisle by means of the device for receiving and transporting storage and retrieval machines. The distance between the storage aisle and the device for receiving and transporting storage and retrieval machines should preferably be kept as short as possible here, but can vary depending on local conditions without departing from the spirit of the invention. In any case, it is essential that the device for receiving and transporting storage and retrieval machines uses the space above existing transport routes for external transport vehicle and preferably enables unhindered operation of both the transport route and the device for receiving and transporting storage and retrieval machines.

Preferably, the transport of containers, both loaded and empty containers, within the high-bay warehouse is fully automated.

### BRIEF DESCRIPTION OF THE DRAWINGS

The invention is explained in more detail below with reference to five figures showing preferred embodiments of the invention. The figures are not intended to limit the scope of the invention.

FIG. 1 shows a plan view of a device for receiving and transporting storage and retrieval machines.

FIGS. 2a) to 2c) show a perspective view of a high-bay warehouse with storage and retrieval machines operated therein and a movable device arranged at the end for receiving and transporting storage and retrieval machines.

FIG. 3a) shows a first embodiment of a device for receiving and transporting storage and retrieval machines.

FIG. 3b) shows a second embodiment of a device for receiving and transporting storage and retrieval machines.

FIG. 4 shows a perspective view of a high-bay warehouse with a device arranged above a transport route for receiving and transporting storage and retrieval machines.

FIG. 5a) shows a side view of a high-bay warehouse with a travel plane for external transport vehicle arranged below the area of the shelf compartments.

FIG. 5b) shows a plan view from above the high-bay warehouse according to FIG. 5a.

### DETAILED DESCRIPTION

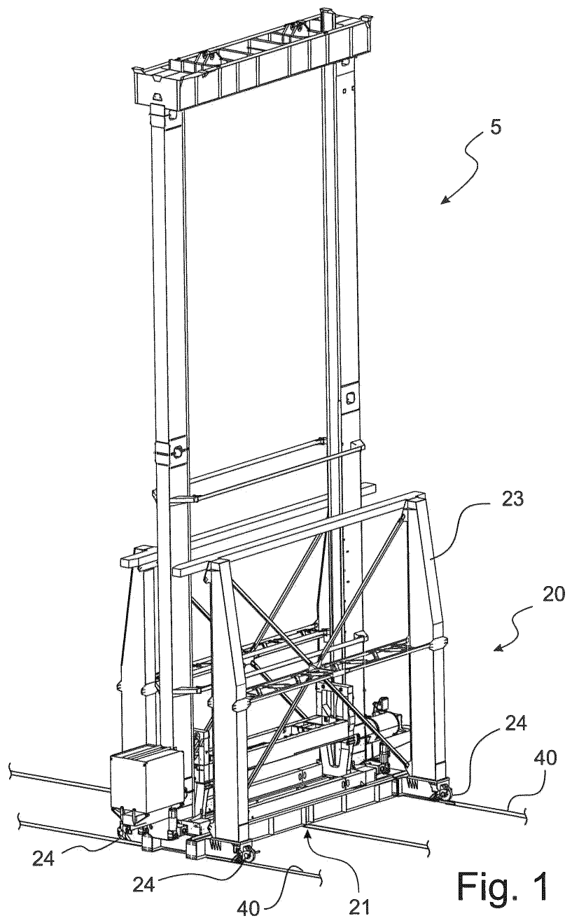

FIG. 1 shows a device 20 which can be moved along parallel rails 40 for transporting a storage and retrieval machine 5. The device 20 has a chassis 21 which has a pair of wheels 24 at each corner, so a total of eight wheels 24, which run on the outer rails 40. Each pair of wheels 24 is assigned a drive (not shown) to accelerate the device 20, which in this embodiment has a deadweight that is approximately the same order of magnitude as the deadweight of the storage and retrieval machine, for example about 200 t, with a width of 11.1 m, a height of 19.3 m and a length of 23.3 m, to a transport speed of about 1.0 m/sec. Above the chassis 21, a frame-like support structure 23 is an integral part of the device 20 for receiving and transporting storage and retrieval machines 5, within which the storage and retrieval machine 5 can be held in a tilt-proof manner in order then to be moved along the rails 40 between the individual storage aisles (not shown) or their longitudinal extensions, or between a waiting position (not shown) and the storage aisles (not shown).

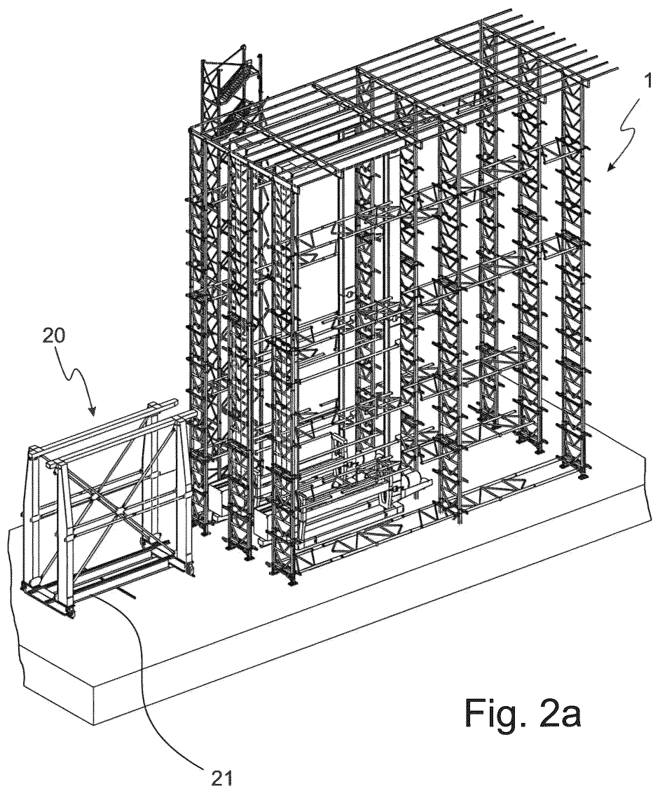

FIGS. 2a) to 2c) show a section of a high-bay warehouse 1 with a device 20 arranged at the end for receiving and transporting storage and retrieval machines 5 perpendicularly to the longitudinal extensions of the storage aisles 4 arranged parallel to one another and above a transport route (not shown) for external transport vehicle. In FIG. 2a), the device 20 has been moved in front of a corresponding storage aisle 4, floor-side rails 7 being provided within the storage aisle 4 up to the device 20, in particular the area above the chassis 21 of the device 20.

FIG. 2b) shows the moving of a storage and retrieval machine 5 out of its corresponding storage aisle 4, the storage and retrieval machine 5 moving out of its roof-side guide within the high-bay warehouse 1 when leaving the storage aisle 4 and then being held exclusively by the support frame 23 of the device 20.

Finally, FIG. 2c) shows the complete removal of the storage and retrieval machine 5 from its corresponding storage aisle and the complete reception of the storage and retrieval machine 5 within the device 20 for receiving and transporting storage and retrieval machines 5. The storage and retrieval machine 5 can thus be transported via the device 20 to any desired storage aisle 4 or to a waiting position (not shown), possibly also outside the high-bay warehouse 1.

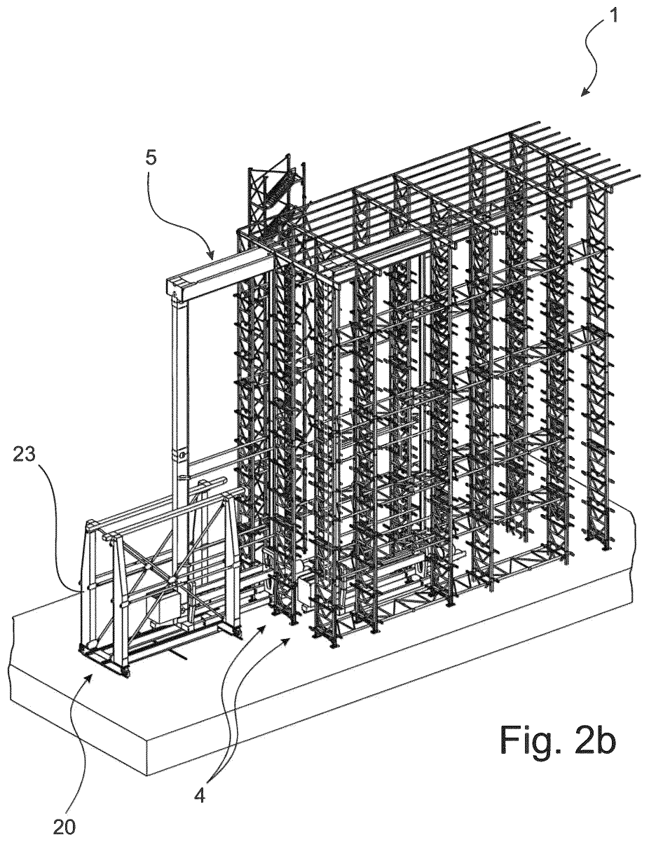

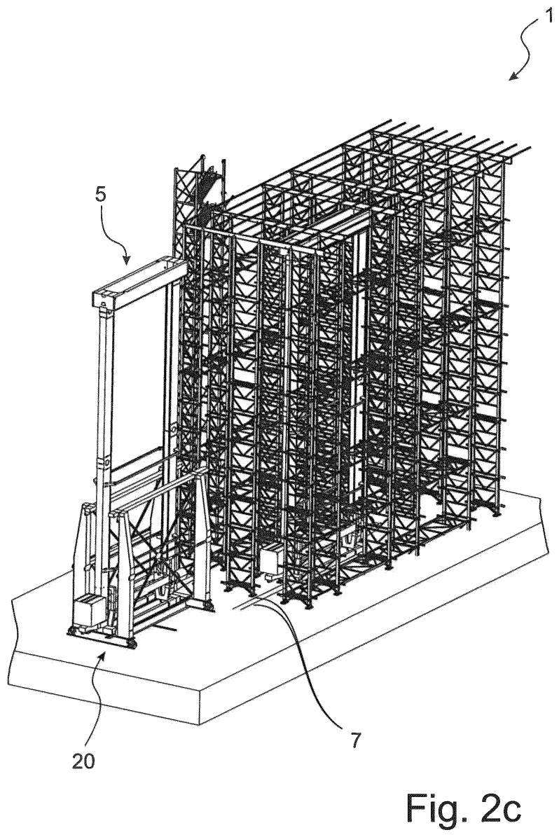

FIG. 3a) shows a use of a device 20 for receiving and transporting storage and retrieval machines (not shown). The device 20 is arranged above a transport route 30 for external transport vehicle 31 in the form of lorries. The chassis 21 of the device 20 consists of a crossbeam 25, along which a storage and retrieval machine (not shown) can be moved in and out of the device 20, as well as supports 26, 27, which are designed below the crossbeam 25 so that they rest on the wheels 24, on the one hand, and, on the other, have a length up to the crossbeam 25, which ensure safe and unhindered operation of the transport route 30. Above the crossbeam 25, supports 26, 27 are in turn dimensioned such that they reliably ensure that a storage and retrieval machine (not shown) is safe from tipping over even when the device 20 is moving.

FIG. 3b) shows a further embodiment of a device 20 for receiving and transporting storage and retrieval machines (not shown) above a transport route 30 for transport vehicle 31, here in the form of lorries. The device 20 has a crossbeam 25 as a chassis 21, which carries wheels 24 arranged in pairs. The wheels 24 rest on the transport route 30 on laterally limiting side boundaries 32, 33 and a central boundary 34 which divides the transport route 30 in the middle. The height of the side boundaries 32, 33, 34 is designed such that the transport route 30 below the travel plane 6 for storage and retrieval machines (not shown) can be used safely and unhindered by the transport vehicle 31, even if the device 20 is moved along the longitudinal direction of the transport route 30 and thus perpendicularly or transversely to the longitudinal orientation of the storage aisles (not shown) on the side boundaries 32, 33 and 34. The supports 26, 27 of the frame-like support structure 23 of the device 20 are designed in such a way that, as in FIG. 3a), a tilt-proof transport of the storage and retrieval machines (not shown) received in the device 20 is ensured even when the device 20 is moving.

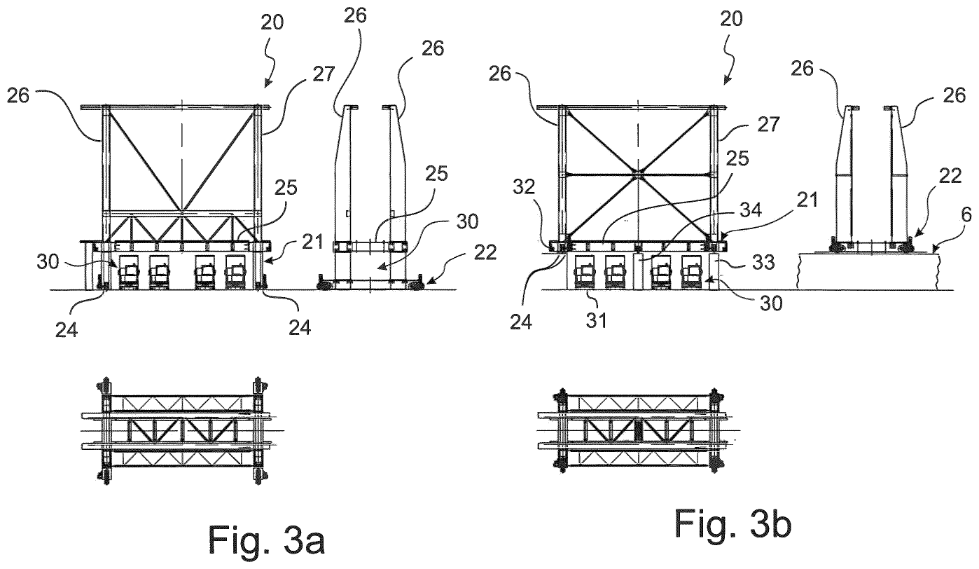

FIG. 4 shows a plan view of a high-bay warehouse 1 with a plurality of storage aisles 4-1, 4-2, 4-3 arranged parallel to one another, in each of which at least one storage and retrieval machine 5 is arranged and can transport containers 2 into or out of the respective storage spaces 15 or separate shelf compartments 3. At the end of the high-bay warehouse 1, a transport route 30 is arranged below the travel plane 6 for storage and retrieval machines 5. A device 20 for receiving and transporting storage and retrieval machines 5 is arranged above the transport route 30 in such a way that it can be moved, on the one hand, perpendicularly to the longitudinal orientation of the storage aisles 4 and, on the other, spans the transport route 30. The movement of the device 20 is dimensioned such that not only is it possible to transport storage and retrieval machines 5 between the individual storage aisles 4-1, 4-2, 4-3, but also to feed storage and retrieval machines out of the high-bay warehouse 1 into the waiting position 60 arranged at the side. For this purpose, the device 20 is arranged in line with the waiting position 60 such that a storage and retrieval machine 5 can be transported out of the device 20 and parallel to the storage aisles 4 into the waiting position 60.

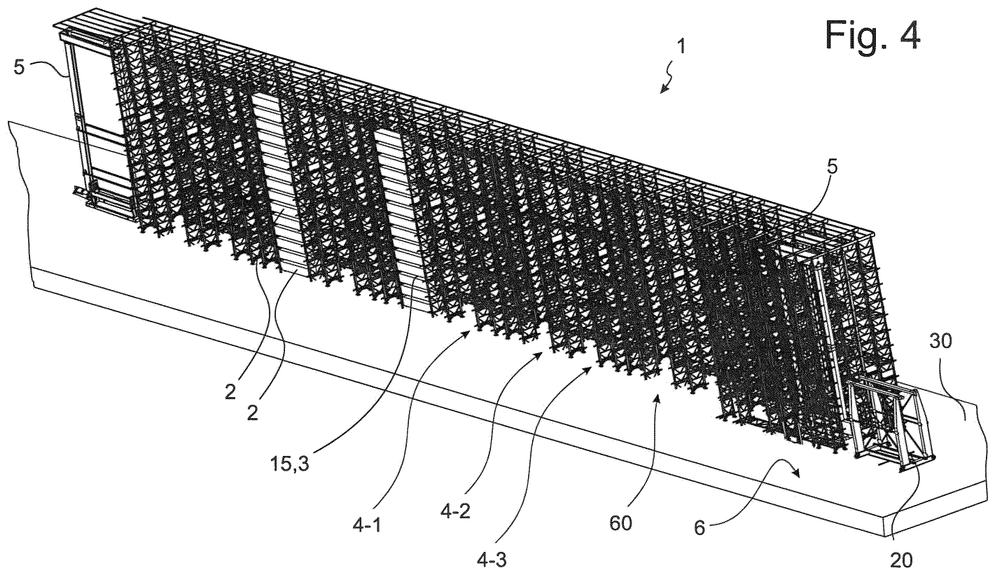

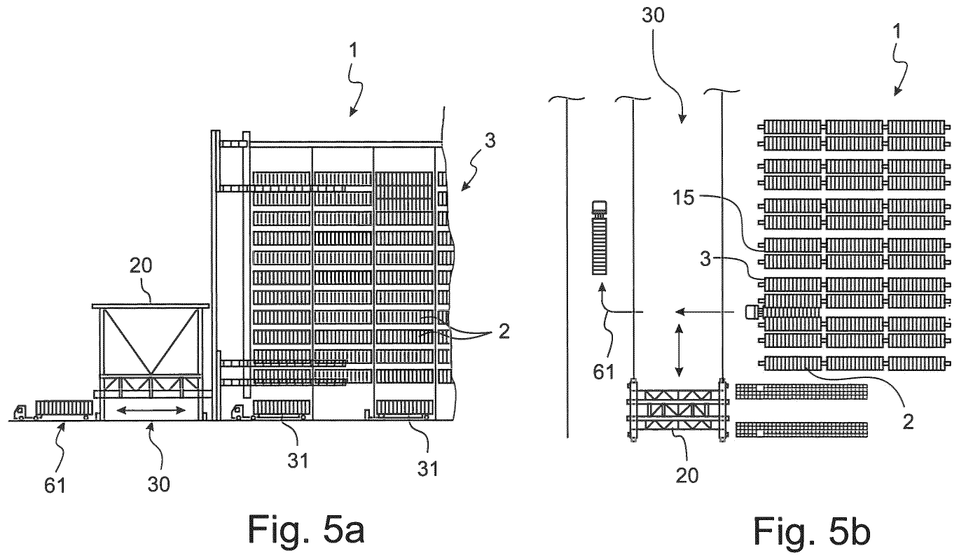

FIG. 5a) shows a side view of a high-bay warehouse 1 with an area having separate shelf compartments 3 for receiving containers 2 and a travel plane for external transport vehicle 31 arranged below the area for separate shelf compartments 3. The external transport vehicle 31 drive from outside into the area of the high-bay warehouse 1 and to parking positions below the separate shelf compartments 3 or storage spaces 15 for containers. From these parking positions, storage and retrieval machines (not shown) can remove the containers 2 from the external transport vehicle 31 and transport them into the high-bay warehouse 1 into the suitable separate shelf compartments 3 or storage spaces 15 for empty containers. Likewise, the containers 2 are removed from the high-bay warehouse 1 via storage and retrieval machines (not shown), which place the containers 2 on the external transport vehicle 31, for example lorries or rail-bound vehicles. In the embodiment shown, the containers 2 are transported out of (or into) the high-bay warehouse 1 by crossing the supply route 61 over the transport route 30, which is spanned by the device 20 for transporting storage and retrieval machines.

FIG. 5b) shows a plan view from above the high-bay warehouse 1 according to FIG. 5a). Below the area for separate shelf compartments 3 and storage spaces 15 for empty containers 2, supply routes 61 for external transport vehicle 31 are provided below the storage aisles 4. Storage and retrieval machines (not shown) can be arranged over the respective parking positions within the supply routes 61 and from there can pick up containers 2 from the external transport vehicle 31 or place them on them. The containers 2 are transported away via the external transport vehicle 31 along the supply route 61, which in the present embodiment crosses the transport route 30 along which the device 20 for transporting storage and retrieval machines also travels, in order then to be transported further, for example, on a road or the like that is independent of the high-bay warehouse 1.

### LIST OF REFERENCE NUMERALS

1 High-bay warehouse
2 Container
3 Separate shelf compartment
4 Storage aisle
5 Storage and retrieval machine
6 Travel plane of the storage and retrieval machines 5
7 Floor-side rails (in storage aisles 4)
15 Storage space for containers 2
20 Device for transporting storage and retrieval machines
21 Chassis
22 Drive
23 Support structure
24 Wheels
25 Crossbeam
26 Supports
27 Supports
30 Transport route
31 Transport vehicle
32 Side boundary
33 Side boundary
40 Rails
60 Waiting position
61 Supply route

1-19. (canceled)

20. A high-bay warehouse (1) for storing and retrieving containers (2), comprising:
storage spaces (15), arranged horizontally adjacent to and vertically above one another, for the containers (2); and
storage aisles (4) arranged between groups of the storage spaces (15) and extending parallel to one another,
storage and retrieval machines (5) capable of moving back and forth in each of the storage aisles (4), the storage and retrieval machines (5) being designed to move the containers (2) vertically and horizontally and into and out of the storage spaces (15);
a transport route (30) for transport vehicles (31) allocated to the high-bay warehouse (1), wherein the transport route (30) is arranged below a travel plane (6) of the storage and retrieval machines (5); and
a device (20) for receiving and transporting at least one of the storage and retrieval machines (5), the device (20) spanning the transport route (30) and being configured to receive the at least one of the storage and retrieval machines (5) and to move the at least one of the storage and retrieval machines (5) between at least two of the storage aisles (4-1, 4-2) perpendicularly to a longitudinal orientation of the storage aisles (4).

21. The high-bay warehouse (1) according to claim 20,
wherein the transport route (30) is arranged on at least one end of the high-bay warehouse (1).

22. The high-bay warehouse (1) according to claim 20,
wherein the device (20) is movable over a distance which corresponds at least to a distance between all of the storage aisles (4) within the high-bay warehouse (1).

23. The high-bay warehouse (1) according to claim 20,
wherein the device (20) moves on rails (40), and
wherein the rails (40) are arranged on both sides of the transport route (30).

24. The high-bay warehouse (1) according to claim 23,
wherein the rails (40) are arranged on side boundaries (32, 33) for the transport route (30).

25. The high-bay warehouse (1) according to claim 20,
wherein at least one waiting position (60) for unused storage and retrieval machines (5) or for maintenance of storage and retrieval machines (5) is provided outside the high-bay warehouse (1), and
wherein the device (20) is configured to be moved between all of the storage aisles (4) and the waiting position (60).

26. The high-bay warehouse (1) according to claim 20,
wherein the storage spaces (15) are suitable for receiving a 20-foot standard container, a 40-foot standard container, two half-length 10-foot standard containers arranged behind one another in their longitudinal direction, or two half-length 20-foot containers arranged behind one another in their longitudinal direction.

27. The high-bay warehouse (1) according to claim 20,
wherein the storage and retrieval machines (5) are configured to move the containers (2) with their longitudinal sides aligned parallel to the storage aisles (4) into and out of the storage spaces (15).

28. The high-bay warehouse (1) according to claim 20,
wherein the storage and retrieval machines (5) are configured to transport the containers (2) in a hanging position and supported from above.

29. The high-bay warehouse (1) according to claim 20,
wherein the storage spaces (15) each have bearings for lower corners of the containers (2).

30. The high-bay warehouse (1) according to claim 20,
wherein the device (20) has
a chassis (21), and
a support structure (23) for supporting the at least one of the storage and retrieval machines (5) received within the device (20) in a tilt-proof manner.

31. The high-bay warehouse (1) according to claim 30,
wherein the support structure (23) has a height which corresponds to at least 25% of a height of a storage and retrieval machine (5).

32. The high-bay warehouse (1) according to claim 20,
wherein the high-bay warehouse (1) is suitable for handling more than 2500 TEU/ha.

33. The high-bay warehouse (1) according to claim 20, wherein the high-bay warehouse (1) is part of a sea or inland port.

34. A method, comprising:
providing a high-bay warehouse (1) with storage spaces (15) for containers (2), the storage spaces (15) being arranged horizontally adjacent to and vertically above one another;
providing storage aisles (4) arranged between groups of the storage spaces (15) and extending parallel to one another,
providing a storage and retrieval machine (5) capable of moving back and forth in each of the storage aisles, the storage and retrieval machine (5) being designed to move the containers (2) vertically and horizontally and into and out of the storage spaces (15);
providing a transport route (30) for transport vehicles (31) allocated to the high-bay warehouse (1), wherein the transport route (30) is arranged below a travel plane (6) of the storage and retrieval machine (5); and
providing a device (20) for receiving and transporting the storage and retrieval machine (5), the device (20) spanning the transport route (30); and
receiving the storage and retrieval machine (5) in the device (20) and moving the storage and retrieval machine (5) between at least two of the storage aisles (4-1, 4-2) perpendicularly to a longitudinal orientation of the storage aisles (4).

35. The method according to claim 34, further comprising:
moving the device (20) along and above the transport route (30) without influencing a movement of the transport vehicles (31) along the transport route (30).

36. The method according to claim 34, further comprising:
guiding the storage and retrieval machine (5) out of a first storage aisle (4-1),
guiding the storage and retrieval machine (5) to the device (20),
receiving the storage and retrieval machine (5) by the device (20);
moving the storage and retrieval machine (5) to a second storage aisle (4-2); and
removing the storage and retrieval machine (5) from the device (20); and
guiding the storage and retrieval machine (5) to the second storage aisle (4-2).

37. The method according to claim 34, further comprising:
guiding the storage and retrieval machine (5) out of a waiting position (60);
guiding the storage and retrieval machine (5) to the device (20),
receiving the storage and retrieval machine (5) by the device (20);
moving the storage and retrieval machine (5) to a storage aisle (4);
removing the storage and retrieval machine (5) from the device (20); and
guiding the storage and retrieval machine (5) into the storage aisle (4).

38. The method according to claim 34, further comprising:
guiding the storage and retrieval machine (5) out of a storage aisle (4);
guiding the storage and retrieval machine (5) to the device (20);
receiving the storage and retrieval machine (5) by the device (20);
moving the storage and retrieval machine (5) to a waiting position (60);
removing the storage and retrieval machine (5) from the device (20); and
guiding the storage and retrieval machine (5) to the waiting position (60).
